(19) United States
(12) Patent Application Publication
(10) Pub. No.: US 2026/0299503 A1
(43) Pub. Date: Oct. 1, 2026

(54) POST-PROCESSING APPARATUS AND IMAGE FORMING APPARATUS THAT BOND SHEET BUNDLE WITH ADHESIVE

(71) Applicant: CANON KABUSHIKI KAISHA, Tokyo (JP)

(72) Inventors: KAITO SUNAMURA, Kanagawa (JP); KENJI TAKAGI, Kanagawa (JP); TAKU WATANABE, Shizuoka (JP)

(21) Appl. No.: 19/573,271

(22) Filed: Mar. 20, 2026

(30) Foreign Application Priority Data
Mar. 26, 2025 (JP) 2025-052435

(51) Int. Cl. G03G 15/00; B42C 9/00

(52) U.S. Cl. CPC G03G 15/6585; B42C 9/0081; G03G 15/6544; G03G 2215/00835; G03G 2215/00936

(57) ABSTRACT

A book-making apparatus includes a support plate, a booklet producing unit, and a control unit. The support plate supports a sheet bundle comprising a plurality of sheets with an adhesive layer formed of toner. The booklet producing unit produces a booklet by heating and pressing the adhesive layer. The control unit controls the booklet producing unit and includes at least a first bonding mode and a second bonding mode. A void ratio, defined as an area ratio between pores and toner in the adhesive layer, is higher in the adhesive layer processed under the first bonding mode than in the adhesive layer processed under the second bonding mode.

### BACKGROUND

### Field of the Technology

The present disclosure relates to a post-processing apparatus and an image forming apparatus that bond a sheet bundle with an adhesive.

### Description of the Related Art

Booklets have been conventionally produced by binding a plurality of sheets with staples, but a booklet producing apparatus has been proposed that produces booklets by bonding a plurality of sheets together using a toner image in place of staples (Japanese Patent Laid-Open No. 2013-043751). Incidentally, a toner image formed on a sheet is re-melted in order to cause the toner image to function as an adhesive. At this time, there are cases where the toner image obscures characters or image information. In Japanese Patent Laid-Open No. 2013-043751, the bonding strength of sheets can be suitably set so as to prevent characters and image information from becoming unreadable when the sheets are bound.

Incidentally, if a single sheet can be separated from a booklet, this may be convenient. For example, it would be convenient if, among the sheets of each of booklets (workshop materials) distributed at a training workshop, the last sheet could be used as a questionnaire sheet for a participant of the training workshop. This has been difficult to realize with a booklet bound by staples. However, since a sheet is separated from the booklet, there can be a problem with the quality of a separation surface, for example, due to paper fibers adhering to the separation surface on the sheet side or on the booklet side. The inventors have found that the quality of the separation surface is affected by a void ratio in an adhesive layer or a physical parameter similar thereto. If the void ratio can be controlled, not only may the quality of the separation surface be improved, but also a range of intended usage of a booklet producing apparatus may be increased.

### SUMMARY

Features of the present disclosure will become apparent from the following description of embodiments with reference to the attached drawings.

The disclosure provides a book-making apparatus comprising a support plate configured to accept and support a sheet bundle formed by a plurality of sheets having an adhesive layer formed using toner, a booklet producing unit configured to heat the adhesive layer in the sheet bundle and press the adhesive layer in the sheet bundle to produce a booklet, and a control unit having at least a first bonding mode and a second bonding mode, and configured to control the booklet producing unit, wherein a void ratio that is an area ratio between pores and toner contained in the adhesive layer to which the first bonding mode was applied is higher than a void ratio of the adhesive layer to which the second bonding mode was applied.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram showing an image forming system.

FIGS. 2A to 2C are diagrams illustrating a formation position of an adhesive image.

FIGS. 3A to 3D are diagrams illustrating a booklet producing method.

FIGS. 4A to 4C are diagrams illustrating heat-press processing.

FIGS. 5A to 5C are diagrams illustrating a void formation mechanism.

FIGS. 6A and 6B are diagrams illustrating a method for measuring a void ratio.

FIGS. 7A and 7B are diagrams illustrating a method for measuring an adhesive force.

FIGS. 8A and 8B are diagram showing measurement results of bonding ratios and void ratios.

FIGS. 9A and 9B are diagram illustrating differences between an embodiment and a comparative example.

FIGS. 10A and 10B are diagrams illustrating an adhesive image.

FIGS. 11A to 11D are diagrams illustrating a cross section of an adhesive layer or separation surfaces.

FIG. 12 is a diagram illustrating a controller.

FIG. 13 is a flowchart showing a booklet producing method.

FIG. 14 is a diagram illustrating another image forming system.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### 1. First Embodiment

### 1-1. Image Forming System

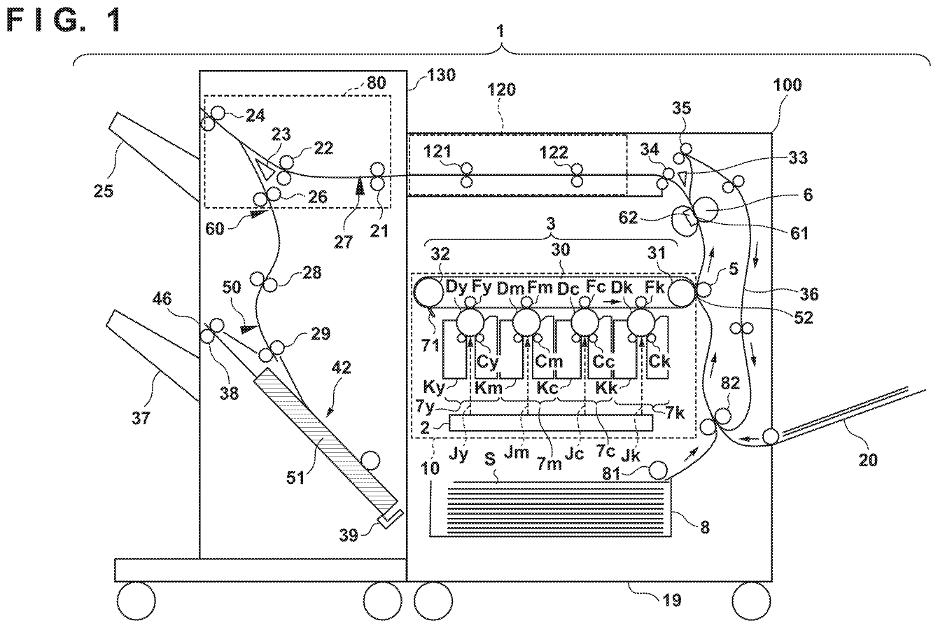

As shown in FIG. 1, an image forming system 1 includes an image forming apparatus 100 and a post-processing apparatus 130. The post-processing apparatus 130 is a sheet processing apparatus connected to the image forming apparatus 100. The image forming apparatus 100 forms an image on a sheet S that is a recording material. An intermediate conveyance unit 120 conveys the sheet S on which the image has been formed to the post-processing apparatus 130. The post-processing apparatus 130 performs post-processing on the sheet S as necessary and outputs the result. Note that the image forming system 1 may be understood as a booklet producing apparatus, or the post-processing apparatus 130 may be understood as a booklet producing apparatus. The image forming system 1 may be referred to as an image forming apparatus.

The image forming apparatus 100 includes a fixing device 6, a sheet cassette 8, an image forming section 10, and a case 19 that accommodates them. The image forming section 10 forms a toner image on the sheet S supplied from the sheet cassette 8. The fixing device 6 executes fixing processing for fixing the toner image to the sheet S.

The sheet cassette 8 is provided in a lower portion of the image forming apparatus 100. The sheet cassette 8 is inserted into the case 19 in a drawable manner, and is capable of accommodating a large number of sheet S. In the present embodiment, it is assumed that the maximum size of a sheet S on which an image can be formed is the A4 size (297 mm in length×210 mm in width). The long sides of the A4-sized sheet S are parallel to the conveyance direction of the sheet S. A feeding roller 81 supplies the sheet S from the sheet cassette 8 and delivers the sheet S to a pair of conveyance rollers 82. A multi-tray 20 is also capable of supplying sheets S one by one.

The image forming section 10 is a tandem-type electrophotographic unit including four process cartridges 7y, 7m, 7c, and 7k, an exposure device 2, and a transfer unit 3. The characters y, m, c, and k represent yellow, magenta, cyan, and black, respectively. Instead of black, transparent toner (powder adhesive) may also be employed. Toner used as the powder adhesive may also be referred to as adhesive toner. The characters y, m, c, and k indicating toner colors may be omitted from reference signs. The adhesive toner may be transparent or may have a black color. When the adhesive toner is transparent, yellow, magenta, and cyan may be mixed as appropriate to realize black (process black). The types (materials) of the yellow toner, magenta toner, and cyan toner and the toner used as the adhesive toner are, for example, thermoplastic resins. Examples of the thermoplastic resins include polyester resins, vinyl-based resins, acrylic resins, styrene-acrylic resins, and the like. The process cartridges 7y, 7m, 7c, and 7k enable a plurality of components responsible for an image forming process to be integrally replaced. In other words, a plurality of components are integrated to form the process cartridges 7y, 7m, 7c, and 7k. Note that the arrangement order of the process cartridges 7y, 7m, 7c, and 7k in a rotation direction of a transfer belt 30 is merely an example. The process cartridges 7y, 7m, 7c, and 7k are examples of replaceable consumable components.

The process cartridges 7y, 7m, 7c, and 7k include corresponding developing devices Ky, Km, Kc, and Kk, photosensitive member drums Dy, Dm, Dc, and Dk, and charging rollers Cy, Cm, Cc, and Ck. The process cartridges 7y, 7m, 7c, and 7k have substantially the same structure except for the types of toner.

The developing devices Ky, Km, Kc, and Kk include containers that accommodate powder (e.g., toner) and application rollers (application sleeves) configured to apply the powder to the photosensitive member drums Dy, Dm, Dc, and Dk, respectively. More specifically, the developing devices Ky, Km, and Kc respectively accommodate yellow toner, magenta toner, and cyan toner for forming a visible image on a sheet S. The developing device Kk accommodates black toner (adhesive toner). The adhesive toner is used to form a user image (document image) and may also be used to heat-press a plurality of sheets S in the post-processing apparatus 130. Note that, by performing development using the adhesive toner, an adhesive image (adhesive layer) is formed on the photosensitive member drum Dk.

The image forming section 10 may also include a fifth process cartridge that uses toner dedicated to adhesion. Note that, in accordance with an intended usage of the image forming apparatus 100, the type of print toner (e.g., black or transparent) and the number of process cartridges 7 can be changed.

The charging rollers Cy, Cm, Cc, and Ck are chargers, and uniformly charge the surfaces of the corresponding photosensitive member drums Dy, Dm, Dc, and Dk, respectively. The exposure device 2 is disposed below the process cartridges 7y, 7m, 7c, and 7k and above the sheet cassette 8. The exposure device 2 irradiates the photosensitive member drums Dy, Dm, Dc, and Dk with corresponding laser beams Jy, Jm, Jc, and Jk, respectively, to form electrostatic latent images thereon. The exposure device 2 may also be referred to as an optical scanning device.

The developing devices Ky, Km, Kc, and Kk attach toner to the electrostatic latent images on the photosensitive member drums Dy, Dm, Dc, and Dk to form toner images, respectively. The developing devices Ky, Km, Kc, and Kk may also be referred to as developing devices.

The transfer unit 3 includes the transfer belt 30 as an intermediate transfer member (secondary image carrier). The transfer belt 30 is an endless belt wound around an inner roller 31 and a tension roller 32. The outer peripheral surface (image formation surface) of the transfer belt 30 faces the photosensitive member drums Dy, Dm, Dc, and Dk. On the inner peripheral side of the transfer belt 30, primary transfer rollers Fy, Fm, Fc, and Fk are disposed so as to face the respective photosensitive member drums Dy, Dm, Dc, and Dk.

The primary transfer rollers Fy, Fm, Fc, and Fk transfer the toner images from the corresponding photosensitive member drums Dy, Dm, Dc, and Dk to the transfer belt 30. The primary transfer rollers Fy, Fm, Fc, and Fk may also be referred to as primary transfer members. As the transfer belt 30 rotates counterclockwise, the toner image is conveyed to a secondary transfer section.

A secondary transfer roller 5 is disposed so as to face the inner roller 31, and a transfer nip 52 is formed between the secondary transfer roller 5 and the transfer belt 30. The transfer nip 52 transfers the toner image from the transfer belt 30 onto the sheet S. The transfer nip 52 may also be referred to as the secondary transfer section. A cleaning blade 71 is a cleaning member for removing toner remaining on the transfer belt 30. Toner scraped off by the cleaning blade 71 is accumulated in a collection container (not illustrated).

Above the secondary transfer roller 5 (downstream in the conveyance direction of the sheet S), a fixing device 6 is disposed. The fixing device 6 applies heat and pressure to the sheet S passing through a fixing nip 61. Accordingly, the toner image is fixed to the sheet S. Note that the fixing device 6 includes a fixing heater 62 for heating the toner image and the sheet S. The fixing heater 62 is, for example, a halogen heater, a ceramic heater, or the like.

As shown in FIG. 1, a switching guide 33 is a flap-shaped guide member provided downstream of the fixing device 6 in the conveyance direction of the sheet S. When a single-sided printing mode in which an image is formed on one side of the sheet S is selected, the switching guide 33 guides the sheet S to discharge rollers 34. When a double-sided printing mode in which images are formed on the two sides of the sheet S is selected, the switching guide 33 guides the sheet S, on which an image has been formed on a first side, to a pair of switchback rollers 35. The pair of switchback rollers 35 convey the sheet S in a predetermined direction. When the trailing edge of the sheet S becomes able to enter a conveyance path 36 for double-sided printing, the pair of switchback rollers 35 start reverse rotation. Accordingly, the sheet S is conveyed to the conveyance path 36 for double-sided printing. The conveyance path 36 for double-sided printing conveys the sheet S to the secondary transfer section again. Accordingly, an image is formed on a second side of the sheet S.

The discharge rollers 34 convey the sheet S to the intermediate conveyance unit 120. The intermediate conveyance unit 120 includes a pair of conveyance rollers 121 and a pair of conveyance rollers 122. The pairs of conveyance rollers 121 and 122 convey the sheet S to the post-processing apparatus 130.

### 1-2. Post-Processing Apparatus

The post-processing apparatus 130 is a floor-standing sheet processing apparatus. The post-processing apparatus 130 includes a mechanism for buffering a plurality of sheets, a mechanism for aligning the plurality of sheets, and a mechanism for bonding (heat-pressing) a sheet bundle.

Hereinafter, an end portion of the sheet S on the front side in the conveyance direction is referred to as a leading edge. An end portion of the sheet S on the rear side in the conveyance direction is referred to as a trailing edge. Of the two end portions of the sheet S, the end portion that enters the post-processing apparatus 130 first is referred to as a first edge. Of the two end portions of the sheet S, the end portion that enters the post-processing apparatus 130 later is referred to as a second edge. Note that, due to switchback conveyance executed by the post-processing apparatus 130, the leading edge may be changed from the first edge to the second edge, and the trailing edge may be changed from the second edge to the first edge.

The sheet S conveyed from the intermediate conveyance unit 120 is delivered to inlet rollers 21 of the post-processing apparatus 130. A sheet sensor 27, which is referred to as an inlet sensor, is disposed downstream of the inlet rollers 21. When the sheet sensor 27 detects the trailing edge of the sheet S, a pair of conveyance rollers 22 accelerate the sheet S. When the trailing edge of the sheet S, whose discharge destination is set to an upper tray 25, reaches a position between the pair of conveyance rollers 22 and a pair of conveyance rollers 24, the pair of conveyance rollers 22 decelerates. Accordingly, the conveyance speed of the sheet S reaches a predetermined discharge speed. The pair of conveyance rollers 24 discharge the sheet S to the upper tray 25.

When the trailing edge of the sheet S, whose discharge destination is set to a lower tray 37, has passed a backflow prevention valve 23, the pair of conveyance rollers 24 stop conveying the sheet S. Thereafter, the pair of conveyance rollers 24 start reverse rotation. Accordingly, the sheet S is switched back and conveyed to a pair of conveyance rollers 26. When a sheet sensor 60 provided downstream of the pair of conveyance rollers 26 detects the leading edge of the sheet S, two rollers constituting the pair of conveyance rollers 24 move away from each other. Accordingly, the pair of conveyance rollers 24 become able to accept a subsequent sheet S. Furthermore, in a state where the pair of conveyance rollers 26 are nipping a preceding sheet S, the pair of conveyance rollers 26 stop. In synchronization with arrival of the subsequent sheet S, the pair of conveyance rollers 26 start reverse rotation. Accordingly, the subsequent sheet S is overlaid on the preceding sheet S. By repeatedly switching back a sheet S using the pair of conveyance rollers 26, a plurality of sheets S are overlaid to form a sheet bundle. Such an operation for forming a sheet bundle may also be referred to as a buffer operation. A unit that realizes the buffer operation is referred to as a buffer section 80. Note that it is not essential that a sheet bundle is formed in the buffer section 80. For example, the buffer section 80 may switch back a sheet S that has arrived from the image forming apparatus 100 and convey the sheet S to an intermediate stacking section 42. In this case, a sheet bundle is formed in the intermediate stacking section 42.

When a sheet bundle is completed in the buffer section 80, the pair of conveyance rollers 26 convey the sheet bundle toward the intermediate stacking section 42. The sheet bundle passes between a pair of conveyance rollers 28 and passes a sheet sensor 50. Furthermore, the sheet bundle is conveyed to the intermediate stacking section 42 by a pair of kick-out rollers 29. At the most downstream portion of the intermediate stacking section 42, a movable longitudinal aligning plate 39 is disposed at a standby position. When the sheet bundle abuts against the longitudinal aligning plate 39, the sheet bundle is aligned.

On the intermediate stacking section 42, a plurality of bundles of sheets are sequentially stacked. Note that a sheet bundle that is first conveyed to the intermediate stacking section 42 is referred to as a first sheet bundle. The i-th sheet bundle that arrives at the intermediate stacking section 42 is referred to as an i-th sheet bundle. A sheet bundle that arrives last at the intermediate stacking section 42 is referred to as an N-th sheet bundle. Accordingly, a predetermined number of sheets S for forming a booklet are stacked on the intermediate stacking section 42. When alignment of the predetermined number of sheets S ends, a heat-press unit 51 executes a binding operation (heat-press processing), thereby forming a booklet. The heat-press processing may be executed each time a sheet bundle arrives at the intermediate stacking section 42. As the longitudinal aligning plate 39 moves from the standby position to a discharge position, the booklet is pushed toward a pair of discharge rollers 38. When a leading edge of the booklet is nipped between the pair of discharge rollers 38, the longitudinal aligning plate 39 stops and returns to the standby position. The pair of discharge rollers 38 discharge the booklet received from the longitudinal aligning plate 39 to the lower tray 37 through a discharge port 46.

In the above description, the post-processing apparatus 130 forms a sheet bundle composed of a plurality of sheets S using the buffer section 80, and conveys the sheet bundle to the intermediate stacking section 42. However, a single sheet S may be conveyed to the intermediate stacking section 42.

### 1-3. Print Region for Adhesive Image Aim

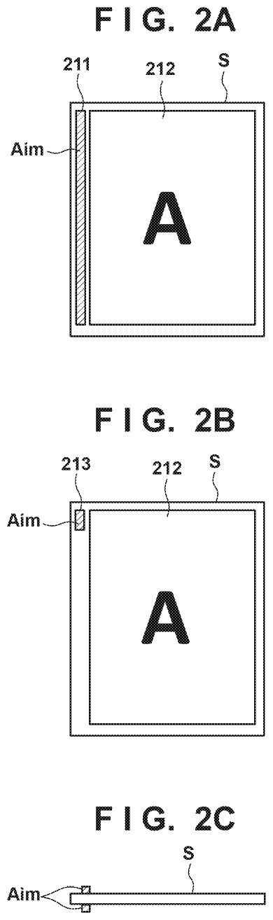

FIG. 2A shows a print region 211 of an adhesive image Aim. The print region 211 is an adhesive region secured in a binding margin of the sheet S. In this example, the print region 211 extends parallel to the long sides of the sheet S. The print region 211 is provided at a left end portion or a right end portion close to a long side. For a right-bound booklet, the print region 211 is disposed at the right edge of the sheet S. For a left-bound booklet, the print region 211 is disposed at the left edge of the sheet S. The print region 211 may be provided in an upper end portion or a lower end portion close to a short side of the sheet S. A plurality of sheets S are stacked in the post-processing apparatus 130, which executes heating processing and pressurizing processing on the print regions 211 of the plurality of sheets S, thereby bonding the plurality of sheets S together to form a booklet. The booklet in this case is a long-side-bound booklet. Here, the width (length in the short-side direction) of an adhesive toner image (the print region 211) is, for example, 4.0 mm. For example, a toner amount per unit area of the adhesive image Aim (coverage) may be 0.38 mg/cm². The print region 212 is a region in which a user image is printed.

As shown in FIG. 2B, a small print region 213 for the adhesive image Aim may be formed in the vicinity of a corner of each sheet S. Accordingly, a corner-bound booklet is formed. An image formed as the adhesive image Aim is not formed on the sheet S serving as the cover sheet of the booklet. For a right-bound booklet, the print region 213 is disposed on the upper right of the sheets S. For a left-bound booklet, the print region 213 is disposed on the upper left of the sheets S.

As shown in FIG. 2C, the print regions 211 and 213 for the adhesive image Aim may be respectively formed on the two sides of the sheet S, or the print region 211 or 213 may be formed on only one side of the sheet S. Whether the print regions 211 and 213 for the adhesive image Aim are respectively formed on the two sides or the print region 211 or 213 is formed on only one side may be selected in consideration of, for example, a bonding capability of the post-processing apparatus 130, a bonding capability of the adhesive image Aim, the type of sheets S, an intended usage of the booklet, and the like. For a booklet handled as an archival edition, reliable bonding performance is required. Reliable bonding performance is also required when thick paper or a special sheet S is used as a cover sheet of the booklet. Accordingly, in such cases, the print region 211 for the adhesive image Aim is provided on both sides of the sheet S. When a simple booklet for one-time use is produced, the print region 211 for the adhesive image Aim may be formed on only one side of the sheets S.

When the adhesive image Aim is formed on both sides of each sheet S, the adhesive image Aim formed on the front side of one sheet S and the adhesive image Aim formed on the back side of another sheet S come into contact with each other, and are bonded to each other. Note that the adhesive image Aim is formed on the back side of the front cover sheet of a booklet and on the front side of the back cover sheet, but is not formed on the front side of the front cover sheet or on the back side of the back cover sheet.

### 1-4. Booklet Producing Operation

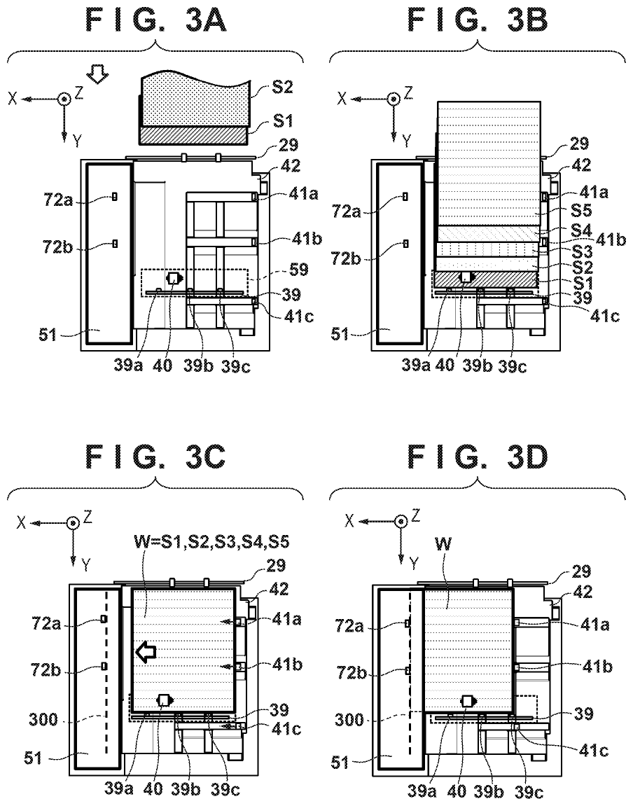

FIGS. 3A to 3D show a booklet producing operation that is executed in the intermediate stacking section 42. An initial state is a state where the intermediate stacking section 42 is empty. As an example, a sheet bundle W formed by five sheets S1 to S5 is conveyed from the buffer section 80 to the intermediate stacking section 42. The intermediate stacking section 42 functions as a support member or a holding member that supports the five sheets S1 to S5.

The Y direction is a direction parallel to a stacking surface (stacking plate) of the intermediate stacking section 42 on which the sheets S are stacked and parallel to the conveyance direction of the sheets S conveyed from the pair of kick-out rollers 29 to the intermediate stacking section 42. The Y direction may be referred to as a longitudinal direction. The X direction is a direction parallel to the stacking surface of the intermediate stacking section 42 on which the sheets S are stacked and orthogonal to the Y direction. The X direction may be referred to as a lateral direction. The Z direction is a direction orthogonal to both the X direction and the Y direction (the normal direction of the stacking surface and the thickness direction of the stacked sheets S). The Z direction may be referred to as a height direction. Directions opposite to the X direction, the Y direction, and the Z direction may be referred to as a −X direction, a −Y direction, and a −Z direction, respectively.

The longitudinal aligning plate 39 and the aligning roller 40 function as a first aligning unit that aligns a plurality of sheets S in a first direction (Y direction). The longitudinal aligning plate 39 is disposed at the most downstream portion of the intermediate stacking section 42 in the Y direction. The longitudinal aligning plate 39 serves as a reference member (first reference member) that defines a reference for a sheet position in the Y direction. The aligning roller 40 is a conveyance member for conveying the sheets S in the Y direction so as to cause the sheets S to abut against and align with the longitudinal aligning plate 39. The longitudinal aligning plate 39 includes a plurality of contact portions 39a to 39c arranged at intervals in the X direction. The contact portions 39a to 39c may also be referred to as longitudinal reference plates. The plurality of contact portions 39a to 39c come into contact with end portions of the sheets S. Note that the longitudinal aligning plate 39 and the aligning roller 40 are integrally configured as a movable unit 59 that is movable in the Y direction. The movable unit 59 is movable in the Y direction due to a driving source such as a motor. That is to say, the positions of the longitudinal aligning plate 39 and the aligning roller 40 in the Y direction can be adjusted. Lateral aligning plates 41a to 41c of a lateral alignment jogger 41 function as an aligning unit that aligns the sheets S in the X direction orthogonal to the Y direction.

The lateral aligning plates 41a to 41c move in the X direction by a driving source such as a motor, and press the side edges of the sheets S stacked on the intermediate stacking section 42. Lateral reference plates 72a and 72b are reference members that define a reference for the position of the sheets S in the X direction. The lateral reference plates 72a and 72b are disposed so as to face lateral aligning plates 41a and 41b in the X direction, respectively.

### 1-4-1. Preparation Stage

As shown in FIG. 3A, the sheets S1 to S5 are conveyed toward the pair of kick-out rollers 29. The sheets S1 to S5 may be conveyed to the intermediate stacking section 42 in a state where a lower-positioned sheet Sj protrudes in the Y direction beyond an upper-positioned sheet Sj+1. Here, j is an index of a sheet S. Before the sheets S are stacked on the intermediate stacking section 42, the longitudinal aligning plate 39 moves in advance to a predetermined standby position in accordance with the size of the sheets S to be aligned. The standby position is set such that the position of the end portions in the −Y direction of the sheets S reaches a predetermined position, independent of the size of the sheets S. In other words, the standby position is a position that is set such that the distance in the Y direction from a nip position of the pair of kick-out rollers 29 to the longitudinal aligning plate 39 is slightly longer than the length in the Y direction of the sheets S. The lateral aligning plates 41a to 41c wait at positions that are spaced outward in the X direction from the sheets S that are being conveyed, so as not to interfere with conveyance of the sheets S.

### 1-4-2. Longitudinal Alignment Stage

FIG. 3B indicates that the trailing edge of a first sheet S1 has passed through a nip of the pair of kick-out rollers 29, and the leading edge of the sheet S1 has reached the aligning roller 40. The sheet S1 is abutted against the longitudinal aligning plate 39, and is aligned based on the position of the longitudinal aligning plate 39. As the aligning roller 40 continues to rotate, the sheets S2 to S5 that reach the aligning roller 40 subsequent to the sheet S1 are sequentially abutted against the longitudinal aligning plate 39. Accordingly, the five sheets S1 to S5 are aligned in the Y direction (longitudinal direction) based on the position of the longitudinal aligning plate 39.

### 1-4-3. Lateral Alignment Stage

FIG. 3C indicates that, after alignment in the Y direction (longitudinal direction) of the sheets S1 to S5 was completed, alignment in the X direction (lateral direction) has been started. The lateral aligning plates 41a to 41c are driven in the X direction, which is an alignment direction, abut against the side edge of the sheets S1 to S5, and press the sheets S1 to S5 toward the lateral reference plates 72a and 72b. Then, as the opposite side edges of the sheets S1 to S5 abut against contact surfaces 300 of the lateral reference plates 72a and 72b, the sheets S1 to S5 are aligned in the X direction (lateral direction) based on the positions of the lateral reference plates 72a and 72b.

### 1-4-4. Bonding Stage (Heat-Pressing Stage)

FIG. 3D shows a state where alignment of the five sheets S1 to S5 in the X direction and the Y direction is complete. A target position (alignment position) in an alignment operation is the position of the sheet bundle W when bonding processing (heat-press) is performed by the heat-press unit 51. As described above, the image forming apparatus 100 forms the adhesive image Aim on the sheets S1 to S5 such that a side on which the adhesive toner image has been formed matches the heat-press unit 51 side. When the sheet S1 is the front cover of a booklet, the adhesive image Aim may not be formed thereon.

The heat-press unit 51 applies heat-pressing to the sheets S1 to S5 that have been aligned. During this time, the lateral aligning plates 41a to 41c recede in the −X direction. Accordingly, the intermediate stacking section 42 becomes able to accept a plurality of next sheets S. Thereafter, a sheet bundle W formed by sheets S6 to S10 and generated in the buffer section 80 is stacked on the sheets S1 to S5.

Thereafter, the above four stages are repeated on the preceding sheet bundle W formed by the sheets S1 to S5 bonded together and the sheet bundle W formed by the sheets S6 to S10 that have not been bonded together. Accordingly, the sheets S1 to S10 are bonded together in an accurately aligned state.

As an example, the sheet bundle W consists of five sheets S. However, the number of sheets S constituting the sheet bundle W may be two, three, or the like. That is to say, it suffices for the number of sheets S included in the sheet bundle W to be no greater than the maximum number of sheets S that can be overlaid on the buffer section 80.

### 1-5. Heat-Press Unit

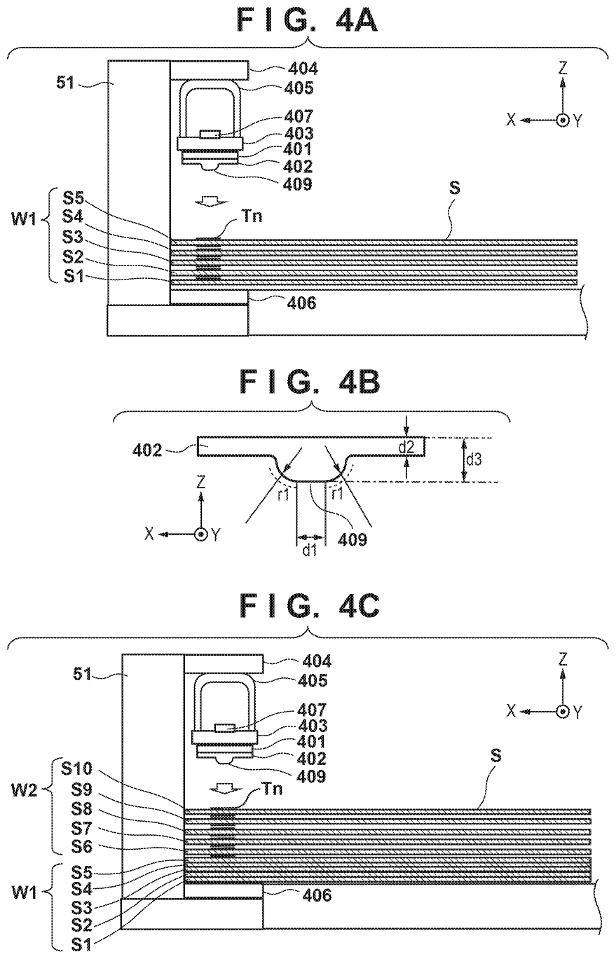

As shown in FIG. 4A, the heat-press unit 51 includes a heater 401 in which a heat-generating element is incorporated as a heating source, and an aluminum heating plate 402 disposed on the heater 401. The surface of the heating plate 402 may be coated to improve releasability with respect to toner. The coating material is, for example, a copolymer of tetrafluoroethylene and perfluoroalkoxy ethylene (PFA). The length (thickness) in the Z direction of the heater 401 is, for example, 1.0 mm. The length (width) in the X direction of the heater 401 is, for example, 8.0 mm. The length in the Y direction of the heater 401 is, for example, 350 mm. The thickness of the heating plate 402 is, for example, 1.5 mm. The heater 401 is, for example, a ceramic heater. The temperature of the heater 401 may be measured by a temperature sensor 407, and be controlled by a control circuit such that the measured temperature reaches a target temperature. For example, the target temperature (e.g., 240° C.) is set such that the surface temperature of a pressurizing section 409 of the heating plate 402 reaches 200° C. By providing the pressurizing section 409 on the heating plate 402, heat and pressure from the heat-press unit 51 are concentrated at a binding position of the sheet bundle W. As a result, heating efficiency and pressing efficiency are improved. The elastic modulus of the pressurizing section 409 is at least 1000 Pa or more, but may be 10000 Pa or more. Accordingly, even when heat-pressing is repeatedly executed, the pressurizing section 409 is less likely to deform.

FIG. 4B shows the dimension of the heating plate 402. Reference sign d1 indicates a length (width) in the X direction of the pressurizing section 409. The length d1 is, for example, 1.0 mm. Reference sign d2 indicates the thickness of the heating plate 402 and is, for example, 0.8 mm. Reference sign d3 indicates a distance (thickness) from the bottom surface of the heating plate 402 to the pressurizing section 409 and is, for example, 1.5 mm. Curved surfaces having a curvature radius rl are respectively formed on the two sides of the pressurizing section 409. The curvature radius rl is, for example, R1.5 mm. The length in the Y direction of the pressurizing section 409 is, for example, 300 mm.

The heater 401 is supported by a heater support 403 made of a resin. A pressurizing lever 404 receives motive power from a motor (not illustrated) to press the heat-press unit 51 in the −Z direction (downward), thereby pressurizing the sheet bundle W. A pressurizing force of the pressurizing lever 404 is transmitted to the pressurizing section 409 via a metal stay 405 serving as a rigid body. The pressurizing force of the pressurizing lever 404 is controllable in accordance with an amount of movement of the pressurizing lever 404 in the −Z direction (downward). Average surface pressure acting on the sheet bundle W is, for example, 0.2 MPa. A heat-press time T1 is, for example, 2.0 seconds. The heat-press time may also be referred to as a contact time, a pressurizing time, or a heating time.

A pressurizing plate 406 is a receiving member formed of an elastic material (e.g., silicone rubber). A reason for adopting an elastic material is that the pressurizing plate 406 is a member configured to stably receive a pressurizing force. The elastic modulus of the pressurizing plate 406 is, for example, 1000 Pa or less. The pressurizing plate 406 may also be provided with a PFA coating. The thickness of the pressurizing plate 406 is, for example, 2.0 mm. The heat-press unit 51 pressurizes a sheet bundle W1 formed by the sheets S1 to S5, and then moves away from the sheet bundle W1. The sheets S1 to S5 in FIG. 4A correspond to first to fifth sheets S1 to S5 of a booklet that is a product. The sheet S1 is the front cover of the booklet. Therefore, the adhesive image Aim is not formed on the lower surface of the sheet S1, and is formed only on the upper surface. The adhesive image Aim is formed on the upper and lower surfaces of each of the sheets S2 to S5, which are second and subsequent sheets of the booklet.

As shown in FIG. 4C, a sheet bundle W2 is stacked on the sheets S1 to S5 that have undergone heat-pressing. The sheet bundle W2 consists of sheets S6 to S10. The heat-press unit 51 applies a heat-press operation to the sheet bundle W2 stacked on the sheet bundle W1. Accordingly, a booklet constituted by a large number of sheets S is produced. Note that the number of sheets constituting the sheet bundle W1 may be different from the number of sheets constituting the sheet bundle W2.

The sheets S6 to S10 that are stacked later are to be included in the same booklet as the sheets S1 to S5. Therefore, the adhesive image Aim is formed on the upper and lower surfaces of each of the sheets S6 to S10.

As an example, the post-processing apparatus 130 is capable of producing a booklet formed by up to 100 sheets S. When production of a booklet starts, the buffer section 80 buffers up to five sheets S at a time to form a sheet bundle W, and supplies the sheet bundle W to the intermediate stacking section 42. Each time a sheet bundle W arrives, the heat-press unit 51 performs the heat-press operation including a descending operation, a pressurizing operation, and an ascending operation. By repeating the buffering operation and the heat-press operation, a booklet is efficiently produced without decreasing the productivity of the image forming apparatus 100.

When the heat-press operation on the sheet bundle W including the last page of the booklet is completed on the intermediate stacking section 42, the longitudinal aligning plate 39 moves from the standby position to the discharge position. That is to say, as the longitudinal aligning plate 39 translates toward the discharge port 46, the completed booklet is pushed out. The pair of discharge rollers 38 are provided at the discharge port 46. When the leading edge of the booklet has passed slightly beyond the pair of discharge rollers 38, the longitudinal aligning plate 39 stops and returns to the standby position. The pair of discharge rollers 38 discharge the booklet to the lower tray 37.

### 1-6. Toner

### 1-6-1. Toner Composition

The process cartridges 7y, 7m, 7c, and 7k respectively accommodate toner Ty, Tm, Tc, and Tk used for both printing and bonding. The toner Ty, Tm, Tc, and Tk contains wax. As the wax, ester wax that is an ester composed of an alcohol and an acid, hydrocarbon-based waxes such as paraffin wax, or the like is adopted. The toner Ty, Tm, Tc, and Tk contains colorants. The yellow toner Ty contains a yellow colorant. The magenta toner Tm contains a magenta colorant. The cyan toner Tc contains a cyan colorant. The black toner Tk contains a black colorant. In this manner, the toner Ty, Tm, Tc, and Tk may contain a magnetic material, a charge control agent, wax, and an external additive. The volume-average particle diameter of the toner Ty, Tm, Tc, and Tk is preferably 5.0 μm or more and 30 μm or less, and more preferably 6.0 μm or more and 20 μm or less.

An example of the composition of the toner Ty, Tm, Tc, and Tk is as follows:
Styrene: 75.0 parts
n-Butyl acrylate: 25.0 parts
Polyester resin: 4.0 parts
(the polyester resin having a weight-average molecular weight (Mw) of 20000, a glass transition temperature (Tg) of 75° C., and an acid value of 8.2 mgKOH/g)
Colorant: 6.5 parts
Ethylene glycol distearate: 14.0 parts
(ester wax obtained by esterifying ethylene glycol and stearic acid)
Hydrocarbon wax: 2.0 parts
Divinylbenzene (crosslinking agent): 0.5 parts

A mixture obtained by combining the above materials was maintained at 60° C., and was stirred at 500 rpm using a stirrer. The materials were uniformly dissolved. As a result, a polymerizable monomer composition was obtained.

On the other hand, into a container provided with a high-speed stirring device, 850.0 parts of a 0.10 mol/L-Na₃PO₄ aqueous solution and 8.0 parts of a 10% hydrochloric acid were added. The rotational speed was set to 15,000 rpm. The temperature was increased to 70° C. Furthermore, 127.5 parts of a 1.0 mol/L-CaCl₂) aqueous solution were added. As a result, an aqueous medium containing a calcium phosphate compound was obtained.

The above polymerizable monomer composition was charged into the aqueous medium, and 7.0 parts of t-butyl peroxypivalate, which is a polymerization initiator, were added. The rotational speed was set to 15,000 rpm. Granulation was carried out for 10 minutes. Thereafter, the high-speed stirring device was replaced with a propeller stirring blade. While refluxing, the reaction was carried out at 70° C. for about 5 hours, after which the liquid temperature was increased to 85° C. Thereafter, the reaction was further continued for about 2 hours.

After the polymerization reaction has ended, the obtained slurry was cooled. Hydrochloric acid was added to the slurry, and the pH thereof was adjusted to 1.4. Furthermore, stirring was carried out for about 1 hour. Accordingly, the calcium phosphate salt was dissolved. Thereafter, washing with an amount of water three times that of the slurry, filtration, and drying were carried out. As a result, toner particles were obtained through classification.

Thereafter, 2.0 parts of silica fine particles (number-average primary particle diameter: 10 nm; BET specific surface area: 170 m²/g) were added as an external additive to 100.0 parts of adhesive toner particles. The mixture was blended for about 15 minutes at 3,000 rpm using a stirrer, whereby the toner Ty, Tm, Tc, and Tk was obtained. The volume-average particle diameter of the toner Ty, Tm, Tc, and Tk was 7.0 μm. The toner Tk is used as an adhesive toner.

### 1-6-2. Viscoelastic Properties of Toner

Physical parameters representing viscoelastic properties of the toner T include a storage modulus G′, a loss modulus G″, and a loss tangent (tan δ). The storage modulus G′ can be measured using a dynamic viscoelasticity measuring apparatus.

Measurement jig: serrated parallel plates having a diameter of 7.9 mm

Measurement sample: 0.1 g of a sample is molded by a compression molding machine into a cylindrical sample having a diameter of 8 mm and a height of 2 mm (a pressurizing force of 15 kN is maintained for one minute at the room temperature).

The temperature of the parallel plates was set to 120° C. Serrations were caused to bite into the cylindrical sample that has been heated and melted. A load was applied to the serrations in a perpendicular direction such that an axial force did not exceed 30 (gf) (0.294 N), thereby fixing the cylindrical sample to the parallel plates. A steel belt may be used such that the diameter of the cylindrical sample becomes equal to the diameter of the parallel plates. The parallel plates and the cylindrical sample were gradually cooled over 1 hour until the temperature of the cylindrical sample reached 30.00° C., which is a measurement start temperature.
Measurement frequency: 6.28 radian/second
Setting of measurement error: an initial value was set to 0.1%, and measurement was executed in an automatic measurement mode.
Sample elongation correction: correction was performed in the automatic measurement mode.
Measurement temperature: the temperature was increased from 30° C. to 140° C. at a rate of 2° C. per minute.
Measurement interval: every 30 seconds, in other words, viscoelastic data was measured at intervals of 1° C.

From a temperature-dependence graph showing the relationship between obtained storage moduli and loss tangents, a storage modulus (G′) and a loss tangent (G″) of the toner T at 120° C. were extracted as representative values. The loss tangent (tan δ) is expressed by the following equation.

$$tan δ = {G}^{″} / {G}^{′} \qquad ( Eq . 1 )$$

In the present embodiment, bonding is executed within a temperature range in which the temperature of the toner T increases from about 90° C. to about 220° C. In the present embodiment, 120° C. is adopted as a representative value, but another temperature may be adopted as a representative value. When the representative temperature changes, bonding conditions in a weak bonding mode and bonding conditions in a normal bonding mode may change. However, also at another temperature, the tendency of the toner melting state is the same, and effects similar to those of the present embodiment can be achieved.

### 1-7. Void Formation Mechanism

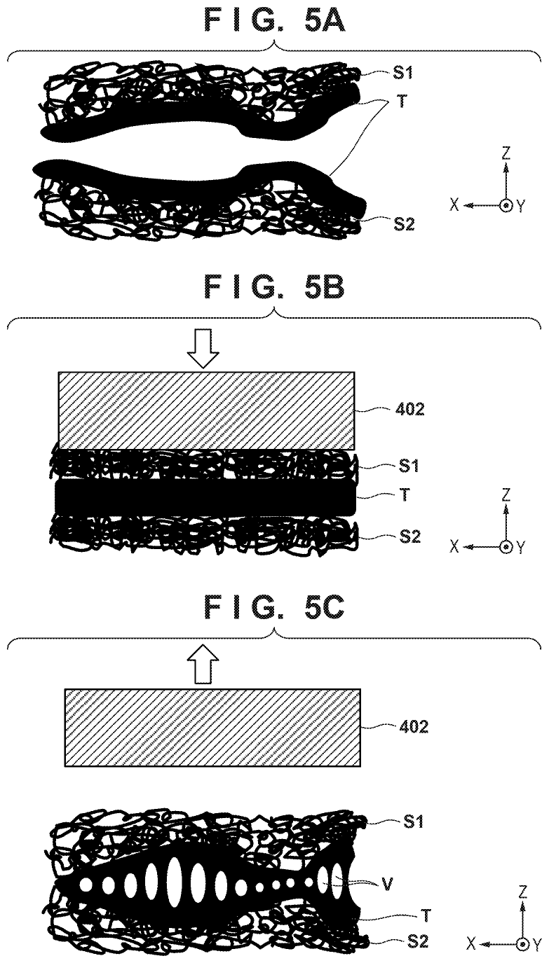

FIGS. 5A to 5C show a void formation mechanism. An adhesive layer interposed between two sheets S includes minute pores. In the present embodiment, these minute pores are referred to as voids.

According to FIG. 5A, the surfaces of two sheets S1 and S2 have a fibrous structure with surface irregularities. Each of the sheets S1 and S2 has a first surface and a second surface. The first surface of the sheet S1 faces the second surface of the sheet S2. The print region 211 is provided on each of the first surface of the sheet S1 and the second surface of the sheet S2. In each print region 211, the adhesive image Aim is printed with toner T.

According to FIG. 5B, the heat-press unit 51 executes heat-press processing. As the heating plate 402 moves relatively toward the pressurizing plate 406, the toner T on the sheet S1 comes into contact with the toner T on the sheet S2, thereby forming an adhesive layer. As the heating plate 402 further moves toward the pressurizing plate 406, the adhesive layer is pressurized, and the heating plate 402 heats the adhesive layer. Accordingly, the toner T melts within the adhesive layer, and the sheets S1 and S2 are bonded to each other via the adhesive layer. Each sheet S has a fibrous structure. Therefore, when the heating plate 402 heats and pressurizes the sheets S1 and S2, surface irregularities of the opposing surfaces of the sheets S1 and S2 are reduced. After a predetermined heat-press time (bonding time) has elapsed, the heating plate 402 starts to move away from the pressurizing plate 406.

As shown in FIG. 5C, when the heating plate 402 has moved away from the pressurizing plate 406, the pressure applied to the adhesive layer is released, and the shapes of the opposing surfaces of the sheets S1 and S2 tend to return to the original shape having surface irregularities. This is because a restoring force acts on the sheets S1 and S2. As a result, the toner T present in recessed portions of the opposing surfaces of the sheets S1 and S2 is stretched, and substantially spherical pores (voids V) are formed. This is the mechanism by which the voids V are formed.

The amount of voids V that are formed depends on the properties of the toner T. In particular, toner T having a high storage modulus has a high capability of resisting the restoring force. That is to say, when the toner T having a high storage modulus is employed in the adhesive layer, the voids V are less likely to be formed in the adhesive layer. On the other hand, toner T having a low storage modulus has a low capability of resisting the restoring force. Thus, the voids V are more likely to be formed in the adhesive layer.

When a force for separating the sheet S1 from the sheet S2 is applied to the sheets S1 and S2, the adhesive layer is destroyed starting from the voids V formed in the adhesive layer. In order to make the sheets S1 and S2 less likely to be separated from each other, it is preferable that the amount of the voids V be small. In order to make the sheets S1 and S2 more likely to be separated from each other, it is preferable that the amount of the voids V be large. However, in order for the sheets S1 and S2 to maintain the form of a booklet, an upper limit value may be set for the amount of the voids V that are formed.

### 1-8. Method for Measuring Void Ratio

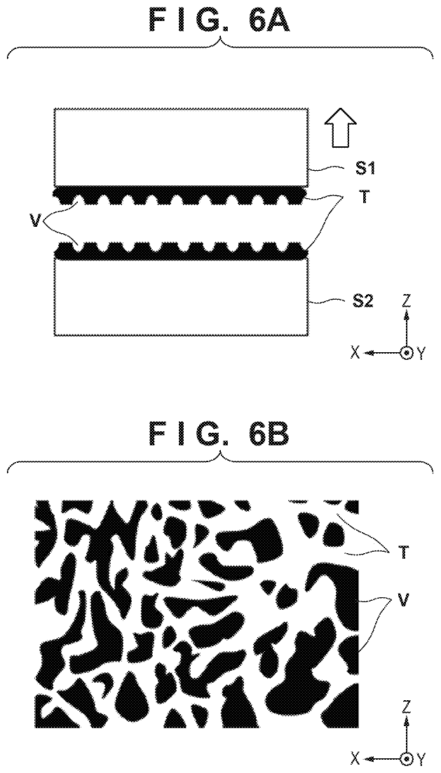

FIG. 6A shows separation surfaces formed between the separated sheets S1 and S2. The separation surfaces are fracture surfaces of the adhesive layer that are formed on the respective opposing surfaces of the sheets S1 and S2 by separating the sheet S2 from the sheet S1. Here, the fracture surfaces are substantially parallel to the surfaces of the sheets S1 and S2. A void ratio is an area ratio between the voids V and the toner T on the separation surfaces. The larger the amount of voids V is, the more the void ratio approaches 1. The smaller the amount of voids Vis, the more the void ratio approaches 0.

FIG. 6B shows a measurement image showing the voids V and the toner T exposed on a separation surface. Here, a method of measuring the void ratio will be described. The separation surface is placed in a vapor atmosphere of ruthenium tetroxide (RuO₄), and the separation surface is stained. For example, the staining pressure is 500 Pa, and the staining time is 15 minutes.

The stained sample is observed with a scanning electron microscope (SEM). The measurement mode is a secondary electron image SE (L). For example, the accelerating voltage is 1.5 kV, and the emission current is 10 μA. The magnification is 130 X.

The image of the separation surface shown in FIG. 6B is a schematic diagram of an image obtained by the SEM. Dark-colored portions indicate voids V. Light-colored portions indicate the toner T that has formed the adhesive layer. The wax is deposited on surfaces of the voids V from the toner T. Since portions on which the wax is deposited are selectively stained, those portions are measured as the dark-colored portions. Thereafter, image processing software calculates a ratio of the dark-colored portions. An image output from the SEM may contain noise. In view of this, the image processing software applies an average curvature blur (Iterations=40) to the entire image. Using a color range selection tool of the image processing software, the dark-colored portions are selected, and the number of pixels of the dark-colored portions is counted. The image processing software calculates an area ratio of the dark-colored portions by dividing the number of pixels of the dark-colored portions by the number of pixels of the entire image. N area ratios are obtained from N SEM images, and an average value of the N area ratios is obtained as a void ratio R. For example, Nis 3.

### 1-9. Method for Measuring Adhesive Force

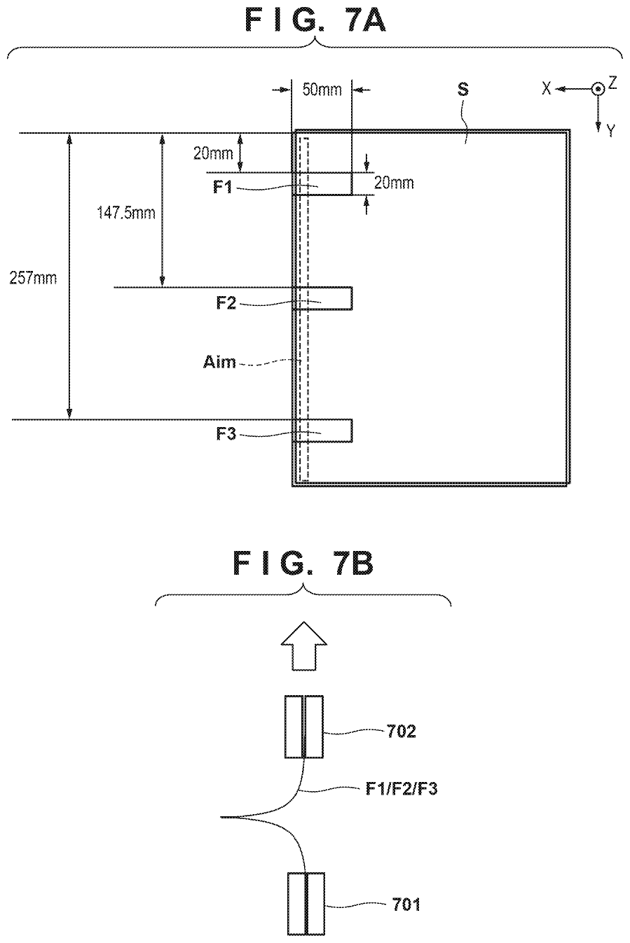

FIGS. 7A and 7B show a method for measuring an adhesive strength (adhesive force). A booklet was formed from two sheets S on which the adhesive image Aim shown in FIG. 2A was formed. The surface of one of the sheets S on which the adhesive image Aim was formed and the surface of the other sheet S on which the adhesive image Aim was formed were bonded to each other. Accordingly, a booklet having an adhesive layer with a total amount of 0.76 mg/cm² was produced. Such a bonding technique is referred to as double-sided bonding. As the sheets S, A4-sized (297 mm×210 mm) Navigator Office Paper Solutions (Navigator Company) was used. The basis weight of the sheets S was 80 g/m². As shown in FIG. 7A, three strip-shaped test pieces F1, F2, and F3 were cut out from the booklet on the end portion side thereof on which the adhesive layer was formed. The test pieces F1, F2, and F3 were cut out at positions located at distances of 20 mm, 147.5 mm, and 257 mm from the upper end of the booklet, respectively. The length (width) in the Y direction of each of the test pieces F1, F2, and F3 was 20 mm. The length in the X direction of each of the test pieces F1, F2, and F3 was 50 mm.

As shown in FIG. 7B, the cut-out test pieces F1, F2, and F3 are held by holding members 701 and 702 of a testing machine. Here, the testing machine is a TENSILON RTG-1225 (A&D Company). The holding member 701 is fixed. As the holding member 702 moves, the test pieces F1, F2, and F3 are pulled up at a speed of 50 mm/min. The testing machine measures a peak strength (N) for each of the test pieces F1, F2, and F3. An adhesive force is the average value of the three obtained peak strengths. Here, furthermore, the average value is converted into a load per unit length (N/cm).

### 1-10. Method for Measuring Bonding Temperature

A bonding temperature is measured by attaching a thermocouple to the print region 211 of the sheet S1. A measuring instrument (with a time resolution set to 0.1 seconds) measures a potential difference signal output from the thermocouple. Accordingly, a peak value of the temperature (bonding temperature) of the sheet S1 during a heat-press operation performed by the heat-press unit 51 is obtained.

### 1-11. Normal Bonding Mode and Weak Bonding Mode

In the present embodiment, a normal bonding mode (strong bonding mode) and a weak bonding mode are used as bonding modes of the heat-press unit 51. The bonding conditions for the bonding modes are as follows. The normal bonding mode is a bonding mode that is applied to sheets S that are not envisioned to be separated in a booklet. The weak bonding mode is a bonding mode that is applied to sheets S envisioned to be separated in the booklet. For example, the weak bonding mode is applied to a questionnaire sheet provided at the end of each booklet distributed at a training workshop. This makes it easy to separate only the questionnaire sheet from the booklet.

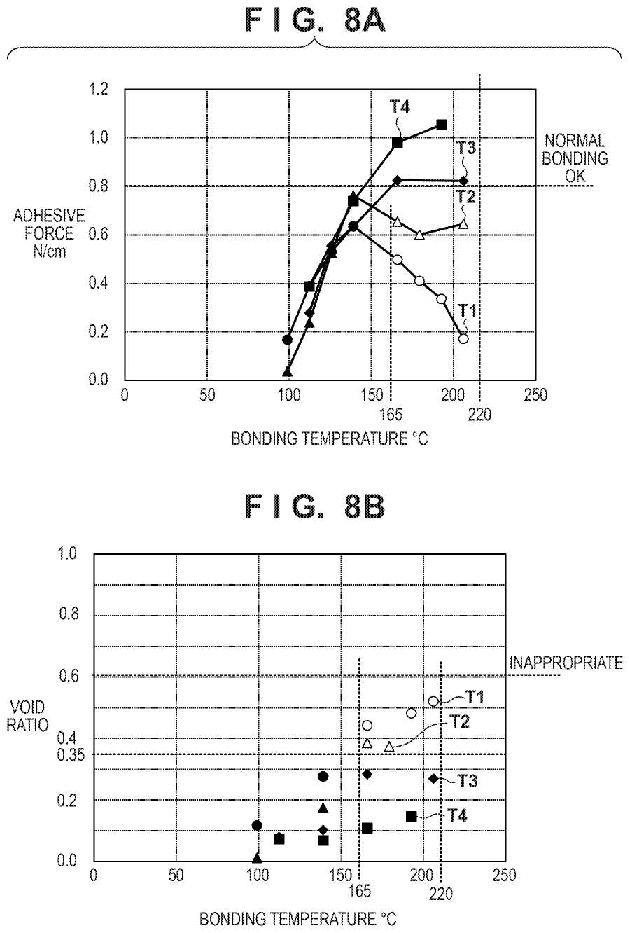

FIG. 8A shows adhesive forces of four types of toner having different storage moduli, which have been measured for bonding temperatures. FIG. 8B shows void ratios of the four types of toner having different storage moduli, which have been measured for bonding temperatures. Here, the storage modulus of toner T1 is 6900 Pa. The storage modulus of toner T2 is 9400 Pa. The storage modulus of toner T3 is 11500 Pa. The storage modulus of toner T4 is 22000 Pa. A storage modulus was changed by adjusting the amount of a crosslinking agent. Circle symbols indicate measurement results of the toner T1. Triangle symbols indicate measurement results of the toner T2. Diamond symbols indicate measurement results of the toner T3. Square symbols indicate measurement results of the toner T4. Among the symbols used in FIGS. 8A and 8B, filled symbols indicate that the quality of the separation surface was determined to be NG (not acceptable), and open symbols indicate that the quality of the separation surface was determined to be OK (acceptable).

An adhesive force in the normal bonding mode (adhesive force per unit distance in the width direction of a test piece) is required to be 0.80 N/cm or more. An adhesive force in the weak bonding mode is required to be less than 0.80 N/cm. Thus, in determination of a bonding quality, when the adhesive force is 0.80 N/cm or more, it is determined that the bonding quality is OK for the normal bonding, and when the adhesive force is less than 0.80 N/cm, it is determined that the bonding quality is OK for the weak bonding.

In determination of quality of a separation surface, when the white background of the paper in the print region 211 appears as dots, the quality of the separation surface is determined as NG, and when the white background is not visible and a uniform toner adhesive layer is visible, the separation surface is determined as OK.

When the bonding temperature exceeded 220° C., discoloration of the sheet S due to scorching was confirmed. Thus, the bonding temperature was set to be lower than or equal to a temperature at which heat-induced discoloration occurs in the sheet S (bonding-start temperature). That is to say, a discoloration start temperature serves as an upper limit value of the bonding temperature. It suffices for the bonding temperature to be lower than the discoloration start temperature.

As shown in FIG. 8A, when a bonding temperature of 140° C. was adopted, the adhesive forces of the toner T1 and T2 were at a maximum. When the bonding temperature was lower than 140° C., there were locations where the toner did not melt and remained as particles, resulting in a reduction in the adhesive force. On the other hand, when the bonding temperature was higher than 140° C., the amount of formation of voids V increased as the storage modulus of the toner decreased. As a result, the adhesive forces of the toner T1 and T2 decreased. When the bonding temperature was 165° C. or higher, the quality of the separation surface was OK, and the adhesive force became lower than 0.65 N/cm.

As shown in FIG. 8A, the higher the bonding temperature is, the higher the adhesive forces of the toner T3 and T4 become. As shown in FIG. 8B, in the toners T3 and T4 having a high storage modulus, the formation of voids V is suppressed. As the bonding temperature increases, toner that has entered gaps between fibers of the sheet S also melts and becomes a portion of the adhesive layer, thereby increasing the adhesive force. In a bonding temperature range of 165° C. or higher, the adhesive force was 0.8 N/cm or higher.

Examining FIG. 8B, the void ratio of each type of the toner T1, T2, T3, and T4 increased as the bonding temperature increased. It was confirmed that, in this manner, a lower storage modulus results in a higher void ratio. It was also confirmed that, when the void ratio increases to 35% or higher, the quality of the separation surface is determined as OK. However, when the void ratio increases to 60% or higher, the adhesive force decreases to 0.2 N/cm or lower. When the adhesive force decreases to 0.2 N/cm or lower, the sheet S is easily separated from the booklet. Thus, a void ratio of 60% or higher may be inappropriate. In addition, in order to maintain the form of a booklet, the lower limit of the adhesive force is set to 0.25 N/cm. An adhesive force of 0.25 N/cm corresponds to a void ratio of 50%. Accordingly, the upper limit value of the void ratio is set to 50%. In other words, the void ratio is required to be lower than 50%.

The void ratio in the normal bonding mode may need to be set to 0% or higher and lower than 35%. The void ratio in the weak bonding mode may need to be set to 35% or higher and 50% or lower. For example, in the normal bonding mode, toner T having a storage modulus of 11500 Pa or higher at 120° C. is employed, and the bonding temperature is set to 165° C. or higher and lower than 220° C. In the weak bonding mode, toner T having a storage modulus of lower than 11500 Pa at 120° C. is employed, and the bonding temperature is set to 165° C. or higher and lower than 220° C.

Incidentally, the storage moduli of the toner Ty, Tm, Tc, and Tk may be different. In this case, in the normal bonding mode, toner T having a relatively high storage modulus is selected as bonding toner. In the weak bonding mode, toner T having a relatively low storage modulus is selected. A plurality of types of toner T having different colors may be mixed to form an adhesive layer. In this case, the storage modulus of the mixed toner can be calculated as a weighted average of the storage moduli of the plurality of types of toner T, weighted by the respective amounts of coverage of the plurality of types of toner T used for color mixing.

In the present embodiment, a bonding time in the normal bonding mode and a bonding time in the weak bonding mode are both four seconds. However, when the bonding time in the weak bonding mode is shorter than the bonding time in the normal bonding mode, the voids V increase. This is because, as the bonding time becomes shorter, a plastic deformation amount of the sheet S decreases, and a shape restoring force becomes higher. For example, the bonding time in the normal bonding mode may be 10 seconds or longer and shorter than 30 seconds. For example, the bonding time in the weak bonding mode may be one second or longer and five seconds or shorter.

### 1-12. Comparison Experimental Results of Separation Surface Quality

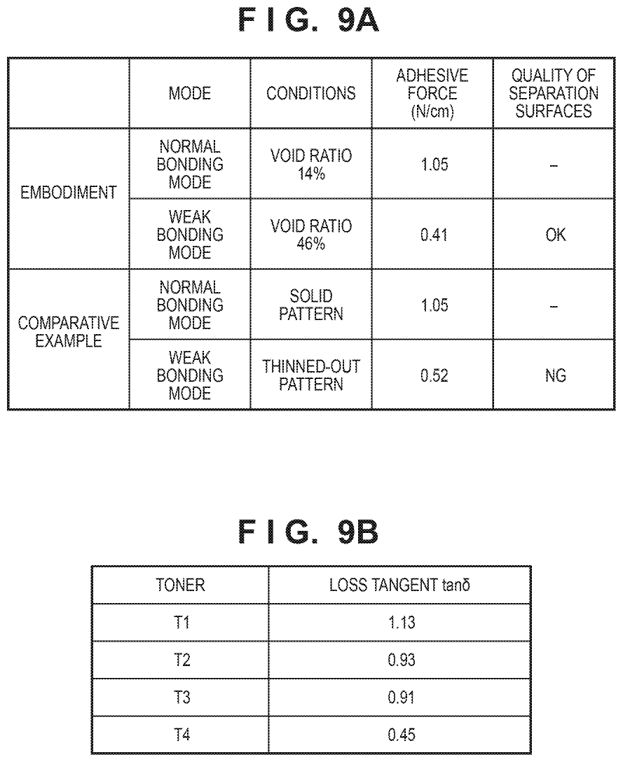

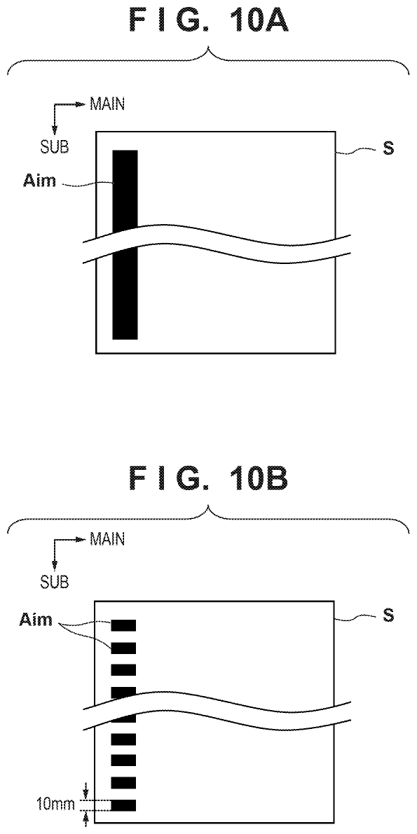

FIG. 9A shows experimental results of the first embodiment, in which a void ratio is reduced to realize a weak adhesive force, and experimental results of Comparative Example 1, in which an area ratio of the coverage of toner T is reduced to realize a weak adhesive force. In the first embodiment, various void ratios are realized based on a storage modulus of toner T and a bonding temperature. In the normal bonding mode, the toner T4 having a storage modulus of 22000 Pa was selected, and the bonding temperature was 190° C. In the weak bonding mode, the toner T1 having a storage modulus of 6900 Pa was selected, and the bonding temperature was 180° C. FIG. 10A shows the adhesive image Aim employed in both the normal bonding mode and the weak bonding mode of the first embodiment. The adhesive image Aim is a so-called solid image.

In the normal bonding mode of Comparative Example 1, the pattern of the adhesive image Aim formed in the print region 211 is a solid pattern shown in FIGS. 2A and 10A. In the weak bonding mode of Comparative Example 1, the pattern of the adhesive image Aim formed in the print region 211 is a thinned-out pattern shown in FIG. 10B. The thinned-out pattern consists of a plurality of small patterns, each having a length of 10 mm in a main scanning direction. An interval between adjacent small patterns is also 10 mm. In this manner, in Comparative Example 1, the adhesive force is adjusted by changing the area of the adhesive image. Note that, in Comparative Example 1, the toner T4 having a storage modulus of 22000 Pa is selected, and the bonding temperature is 190° C.

According to FIG. 9A, the adhesive force in the normal bonding mode of the first embodiment is 1.05 N/cm. This exceeds 0.8 N/cm, which is a criterion for an adhesive force required in the normal bonding mode. The adhesive force in the weak bonding mode of the first embodiment is 0.41 N/cm. This satisfies a condition of being lower than 0.65 N/cm and higher than 0.25 N/cm, which is a criterion for an adhesive force for the weak bonding mode.

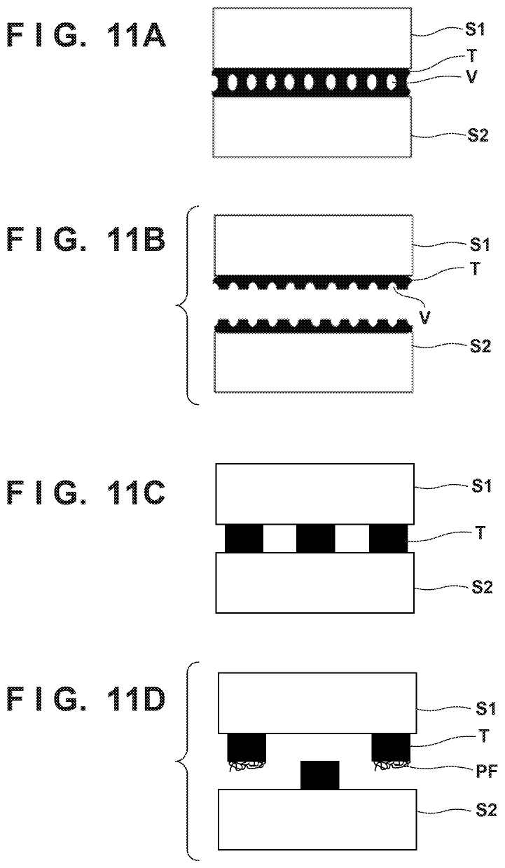

FIG. 11A shows a cross section of an adhesive layer in the weak bonding mode according to the first embodiment. FIG. 11B shows separation surfaces in the weak bonding mode according to the first embodiment. On the separation surfaces, only a uniform layer of toner T and voids V are present, and the white background of the paper is not visible. Thus, the quality of the separation surfaces was determined as OK.

On the other hand, in Comparative Example 1, the adhesive force in the normal bonding mode is 1.05 N/cm. In Comparative Example 1, the adhesive force in the weak bonding mode is 0.52 N/cm. This adhesive force satisfies a condition of being lower than 0.65 N/cm and higher than 0.25 N/cm, which is the criterion for an adhesive force for the weak bonding mode.

FIG. 11C shows a cross section of an adhesive layer in the weak bonding mode according to Comparative Example 1. FIG. 11D shows separation surfaces in the weak bonding mode according to Comparative Example 1. Fibers peeled from the paper adhered to portions of the separation surfaces. Thus, the quality of the separation surfaces was determined as NG. Since the normal bonding mode is not intended to allow separation, the quality of the separation surfaces in the normal bonding mode was not evaluated.

### 1-13. Controller

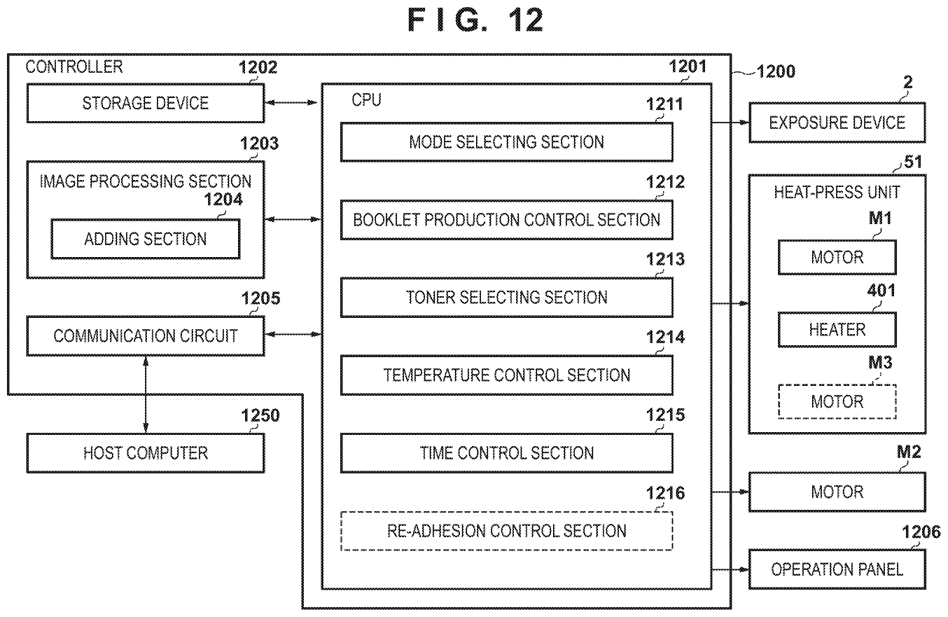

FIG. 12 shows a controller 1200 of the image forming system 1. A plurality of functions provided in the controller 1200 may be distributed among a plurality of controllers (e.g., a printer controller and an engine controller). In FIG. 12, the broken line indicates an optional function.

A CPU 1201 realizes various functions by executing control programs stored in a storage device 1202. Some or all of these functions may be realized by a hardware circuit such as a specific application integrated circuit (ASIC) or a field programmable gate array (FPGA). The storage device 1202 may include a read-only memory (ROM), a random-access memory (RAM), a hard disk drive (HDD), a solid-state drive (SSD), and the like.

The heat-press unit 51 includes a motor M1 that drives the pressurizing lever 404, and the heater 401. A motor M2 rotationally drives, for example, rotary members such as the feeding roller 81. A motor M3 is optional and moves the lateral reference plates 72a and 72b in the +X direction or the −X direction. This is useful for mechanically adjusting the pressurizing position of the pressurizing section 409.

An operation panel 1206 includes input devices such as a touch sensor and switches, and a display device such as a liquid crystal display. A communication circuit 1205 communicates with external apparatuses such as a print server and a host computer 1250.

The CPU 1201 realizes a plurality of functions in accordance with control programs stored in the storage device 1202. A mode selecting section 1211 accepts a bonding-mode selection input that has been input by the user via the operation panel 1206, and stores, in the storage device 1202, selection information indicating the bonding mode selected by the user. The mode selecting section 1211 functions as an acceptance unit configured to accept the selection input. Here, the selection information may include information indicating that a single bonding mode is to be applied to the entire booklet, or information indicating a bonding mode to be applied to each page. For example, the selection information may indicate that, in a booklet formed by M sheets S, the normal bonding mode is to be applied to the first sheet S through the (M−1)th sheet S, and the weak bonding mode is to be applied to the Mth sheet S. The mode selecting section 1211 may also create selection information by analyzing job information received from the host computer 1250 via the communication circuit 1205, and store the created selection information in the storage device 1202. In this manner, the mode selecting section 1211 may function as an acceptance unit configured to accept input designating a page to which the weak bonding mode is to be applied.

A booklet production control section 1212 controls formation of a user image and the adhesive image Aim on each sheet S, and heat-press processing performed by the heat-press unit 51. The booklet production control section 1212 reads the selection information from the storage device 1202, specifies the bonding mode designated by the selection information, and notifies the bonding mode to a toner selecting section 1213, a temperature control section 1214, and a time control section 1215. The toner selecting section 1213 selects toner T for forming the adhesive image Aim in accordance with the bonding mode, and notifies the selected toner T to an adding section 1204 of an image processing section 1203. The image processing section 1203 generates image signals for a user image (a document, a photograph, or other data) optionally prepared by the user by deploying job information. The adding section 1204 generates image signals for forming the adhesive image Aim on a sheet S using the toner T selected by the toner selecting section 1213, and adds the generated image signals to the image signals of the user image. The image signals are output to the exposure device 2.

The temperature control section 1214 sets, in the heater 401, a bonding temperature (heating temperature) corresponding to the designated bonding mode. The time control section 1215 sets, in the motor M1, a heat-pressing time (which may also be referred to as a bonding time, a heating time, or a pressurizing time) corresponding to the designated bonding mode.

A re-adhesion control section 1216 is optional. The re-adhesion control section 1216 controls the heat-press unit 51 such that a separated sheet S re-adheres to the booklet or a plurality of separated sheets S are bonded together to produce a new booklet. The latter usage includes combining, into one booklet, a plurality of questionnaire sheets filled in by different participants of a training workshop, for example.

### 1-14. Flowchart

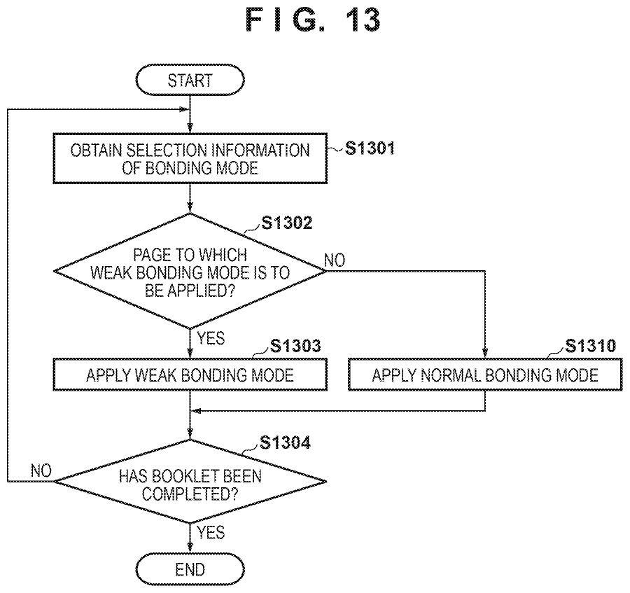

FIG. 13 is a flowchart showing processing for correcting the position of an adhesive image. Upon receiving a print job from an external apparatus, the CPU 1201 executes the following processing.

In S1301, the CPU 1201 (the booklet production control section 1212) obtains selection information of a bonding mode. As described above, the CPU 1201 (the mode selecting section 1211) obtains selection information via the operation panel 1206, reads selection information from the storage device 1202, or extracts selection information from a print job.

In S1302, the CPU 1201 (the booklet production control section 1212) starts to produce a booklet, and determines whether or not a page that is currently processed is a page to which the weak bonding mode is to be applied, based on the selection information. If the page is a page to which the weak bonding mode is to be applied, the CPU 1201 advances the procedure from S1302 to S1303.

In S1303, the CPU 1201 (the booklet production control section 1212) applies the weak bonding mode to the page that is currently processed. Accordingly, toner T for the weak bonding mode is used for the adhesive image Aim for this page, and a bonding temperature and a bonding time for the weak bonding mode are set in the heat-press unit 51. The CPU 1201 then advances the procedure from S1303 to S1304.

On the other hand, if the page is not a page to which the weak bonding mode is to be applied, the CPU 1201 advances the procedure from S1302 to S1310. In S1310, the CPU 1201 (the booklet production control section 1212) applies the normal bonding mode to that page. Accordingly, toner T for the normal bonding mode is used for the adhesive image Aim for that page, and a bonding temperature and a bonding time for the normal bonding mode are set in the heat-press unit 51. The CPU 1201 then advances the procedure from S1310 to S1304.

In S1304, the CPU 1201 (the booklet production control section 1212) determines whether or not a booklet has been completed. For example, upon completion of image formation and heat-press processing of all of the sheets S in the number of sheets designated by the print job, the CPU 1201 determines that a booklet has been completed. If a booklet has not been completed, the CPU 1201 returns the procedure from S1304 to S1302, and processes the next page.

### 1-15. Summary

In the first embodiment, the weak bonding mode is employed in which voids V are intentionally formed in an adhesive layer, thereby enabling a sheet S to be separated starting from the voids V. Accordingly, paper fibers are less likely to be damaged due to separation, and it is possible to produce a booklet with a favorable visual quality of separation surfaces.

In the first embodiment, the toner T for the normal bonding mode and the toner T for the weak bonding mode are different, but this is merely an example. The toner T for the normal bonding mode and the toner T in the weak bonding mode may be of the same type. In this case, however, the bonding temperature for the weak bonding mode is set to be lower than the bonding temperature for the normal bonding mode. Note that the bonding temperature for the weak bonding mode is set such that a suitable amount of voids V is formed in the adhesive layer.

The weak bonding mode enables a sheet to be separated from a booklet without damaging the paper. Therefore, it is also possible to cause the separated paper to re-adhere to the booklet. Specifically, when the separated sheet S is inserted through the discharge port 46, the re-adhesion control section 1216 causes the pair of discharge rollers 38 to perform reverse rotation. Accordingly, the pair of discharge rollers 38 set the sheet S in the intermediate stacking section 42. Alternatively, the user places the separated sheet S in the cassette 8. The re-adhesion control section 1216 feeds the sheet S from the cassette 8, conveys the sheet S through the image forming apparatus 100 and the post-processing apparatus 130, and sets the sheet S in the intermediate stacking section 42. Alternatively, the discharge port 46 may function as an insertion port through which the sheet S can be manually set in the intermediate stacking section 42. When an instruction to execute a re-adhesion mode is given via the operation panel 1206, the re-adhesion control section 1216 controls the heat-press unit 51 to execute heat-press processing. Accordingly, a booklet is produced again and is discharged.

The intermediate stacking section 42 is an example of a support unit configured to accept and support a sheet bundle W formed by a plurality of sheets S having an adhesive layer formed using toner T. The heat-press unit 51 is an example of a booklet producing unit configured to heat the adhesive layer in the sheet bundle W and pressurize the adhesive layer in the sheet bundle W to produce a booklet. The controller 1200 is an example of a control unit having at least a first bonding mode (e.g., the weak bonding mode) and a second bonding mode (e.g., the normal bonding mode), and configured to control the booklet producing unit. A void ratio that is an area ratio between pores and toner contained in an adhesive layer to which the first bonding mode was applied is higher than a void ratio in an adhesive layer to which the second bonding mode was applied. Accordingly, an image forming apparatus (the image forming apparatus 100, the image forming system 1) focusing on void ratios of adhesive layers or physical parameters similar thereto is provided.

For example, the first bonding mode is applied to a sheet S that is envisioned to be separated from a booklet. Accordingly, it can be easy to separate the sheet S from the booklet.

The second bonding mode is applied to a sheet S that is not envisioned to be separated from a booklet. Accordingly, it can be possible to firmly hold, in the booklet, the sheet S that is not envisioned to be separated.

A heating temperature (e.g., 180° C.) of an adhesive layer in the first bonding mode is lower than a heating temperature (e.g., 190° C.) of an adhesive layer in the second bonding mode. Accordingly, it can be easy to separate, from a booklet, a sheet S to which the first bonding mode was applied.

At 120° C., a storage modulus of toner for forming an adhesive layer to which the first bonding mode is to be applied is lower than a storage modulus of toner for forming an adhesive layer to which the second bonding mode is to be applied. Accordingly, the quality of separation surfaces of a sheet S to which the first bonding mode was applied can be favorable.

The first bonding mode is applied to an adhesive layer formed using toner T having a storage modulus of less than 11500 Pa at 120° C. The second bonding mode is applied to an adhesive layer formed using toner T having a storage modulus of 11500 Pa or more at 120° C. Accordingly, the quality of separation surfaces of a sheet S to which the first bonding mode was applied can be favorable. A sheet S to which the second bonding mode was applied can be firmly held in a booklet.

As indicated by FIG. 8B, a void ratio in an adhesive layer to which the first bonding mode was applied is 35% or higher. A void ratio in an adhesive layer to which the second bonding mode was applied is lower than 35%. Accordingly, the quality of separation surfaces of a sheet S to which the first bonding mode was applied can be favorable. A sheet S to which the second bonding mode was applied can be firmly held in a booklet.

The void ratio in the adhesive layer to which the first bonding mode was applied is 35% or higher and 50% or lower. Accordingly, it can be easy for a book including a sheet S that can be separated to maintain the form of a booklet.

A heating temperature that is applied to an adhesive layer in the first bonding mode and the second bonding mode is 165° C. or higher and lower than a temperature (e.g., 220° C.) at which heat-induced discoloration occurs in the sheet S. Note that the temperature at which heat-induced discoloration occurs in the sheet S may differ depending on a type of sheet S. In this case, the temperature control section 1214 may set an upper limit value of a bonding temperature in accordance with the type of sheet S input through the operation panel 1206 or from the host computer 1250. The relation between types of sheet S and upper limit values of the bonding temperature may be stored in the storage device 1202 in advance and referenced by the temperature control section 1214.

A heating temperature of toner T to which the first bonding mode is to be applied is higher than a heating temperature (e.g., 140) at which the adhesive force of an adhesive layer formed using the toner T is maximum.

A heating time of an adhesive layer in the first bonding mode is shorter than a heating time in the second bonding mode. For example, the heating time of the adhesive layer in the first bonding mode may be 1 second or longer and 5 seconds or shorter, and the heating time in the second bonding mode may be 10 seconds or longer and shorter than 30 seconds.

The operation panel 1206, the communication circuit 1205, and the mode selecting section 1211 function as an acceptance unit configured to accept selection input for selecting the first bonding mode or the second bonding mode. Similarly, the operation panel 1206, the communication circuit 1205, and the mode selecting section 1211 function as an acceptance unit configured to accept input designating a page to which the first bonding mode is to be applied.

A control unit (e.g., the re-adhesion control section 1216) may also have a re-adhesion mode in which the support unit supports a plurality of sheets separated from one or more booklets, and the booklet producing unit causes the plurality of sheets to re-adhere. According to the first embodiment, the quality of separation surfaces is favorable, and thus it can be easy for the sheets S to re-adhere.

The image forming section 10 is an example of an image forming unit configured to form an image on a sheet S using toner T. The fixing device 6 is an example of a fixing unit configured to fix the image to the sheet S.

The intermediate stacking section 42 executes a supporting process of accepting and supporting a sheet bundle W formed by a plurality of sheets S having an adhesive layer formed using toner T. The heat-press unit 51 executes a booklet producing process of heating the adhesive layer in the sheet bundle W and pressurizing the adhesive layer in the sheet bundle W to produce a booklet. The controller 1200 executes a control process of controlling the booklet producing process using the first bonding mode or the second bonding mode.

### 2. Second Embodiment

In the first embodiment, the storage moduli of toner T are adopted as physical parameters for controlling void ratios. However, this is merely an example. Storage moduli may be replaced with loss tangents (tan δ). In view of this, in a second embodiment, loss tangents (tan δ) will be described as physical parameters adopted for a plurality of bonding modes. In the second embodiment, descriptions of matters common to the first embodiment are omitted, and the descriptions of the first embodiment are incorporated by reference.

### 2-1. Bonding Conditions for Normal Bonding Mode and Weak Bonding Mode

FIG. 9B shows the loss tangents of toner T1 to T4. The amount of formation of voids V in an adhesive layer varies depending on a loss tangent. As the loss tangent increases, the toner T in the adhesive layer is more easily stretched, and voids V are more likely to be formed. As the loss tangent decreases, the toner T is less easily stretched, and voids V are less likely to be formed.

As shown in FIG. 8A, when the bonding temperature is 140° C., the adhesive forces of the toner T1 and the toner T2 reach the maximum values, respectively. When the bonding temperature decreases below 140° C., the adhesive forces decrease. As shown in FIG. 8A, when the bonding temperature increases above 140° C., the adhesive forces decrease. When the bonding temperature increases to 165° C. or higher, the quality of a separation surface is determined as OK. The adhesive forces at this time are lower than 0.65 N/cm.

As shown in FIG. 8A, the higher the bonding temperature is, the greater the adhesive forces of the toner T3 and toner T4 become. This is because a low loss tangent suppresses formation of voids V, and because toner that has entered gaps between sheets also melts and functions as a portion of the adhesive layer. When the bonding temperature is 165° C. or higher, the adhesive force is 0.8 N/cm or more.

As shown in FIG. 8B, in the normal bonding mode, the toner T having a loss tangent of 0.91 or less at 120° C. is selected, and the bonding temperature is set to be 165° C. or higher and lower than 220° C. Note that the lower limit of a loss tangent in the normal bonding mode is about 0.2. In the weak bonding mode, the toner T having a loss tangent greater than 0.91 at 120° C. is selected, and the bonding temperature is set to be 165° C. or higher and lower than 220° C. The upper limit value of a loss tangent in the weak bonding mode is about 2.5.

According to the second embodiment, at 120° C., the loss tangent of toner for forming an adhesive layer to which the first bonding mode (e.g., the weak bonding mode) is to be applied is greater than the loss tangent of toner for forming an adhesive layer to which the second bonding mode (e.g., the normal bonding mode) is to be applied. Accordingly, a sheet S to which the first bonding mode was applied is easily separated from a booklet. Furthermore, the quality of the separation surface of the separated sheet S can be favorable.

The first bonding mode is applied to an adhesive layer formed by toner having a loss tangent greater than 0.91 at 120° C. The second bonding mode is applied to an adhesive layer formed by toner having a loss tangent of 0.91 or less at 120° C.

### 3. Third Embodiment

In the first and second embodiments, the post-processing apparatus 130 including the heat-press unit 51 is disposed side by side with the image forming apparatus 100. However, this is merely an example.

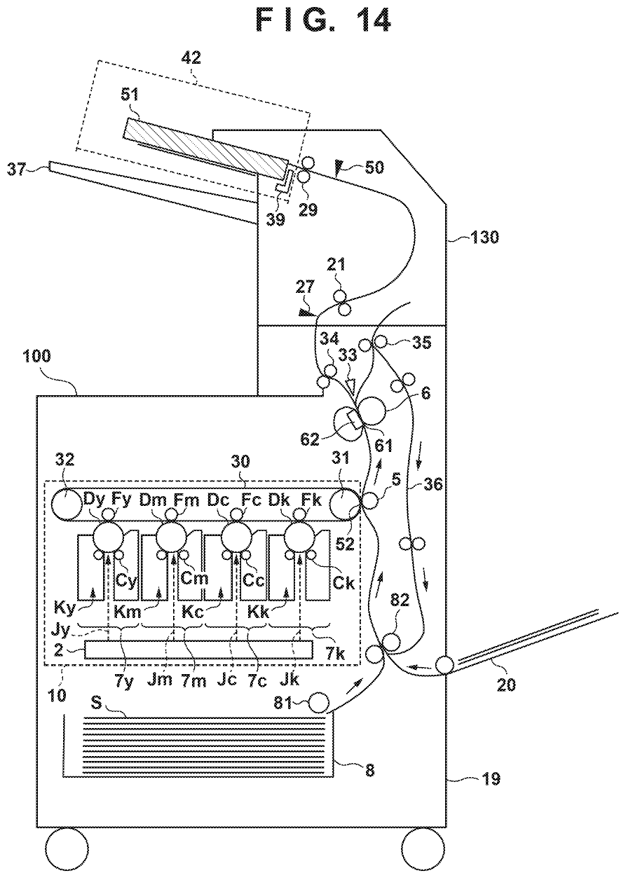

As shown in FIG. 14, the post-processing apparatus 130 and the heat-press unit 51 may be arranged in an upper portion of the main body of the image forming apparatus 100. In this case, the discharge rollers 34 directly deliver each sheet S to the post-processing apparatus 130. When the sheet sensor 27 detects the leading edge of the sheet S, the inlet rollers 21 convey the sheet S. Furthermore, the pair of kick-out rollers 29 convey the sheet S to the intermediate stacking section 42. Note that the direction in which the sheet S is conveyed to the intermediate stacking section 42 in FIG. 14 is opposite to the conveyance direction in which the sheet S is conveyed to the intermediate stacking section 42 in FIG. 1.

The arrangement of the intermediate stacking section 42 shown in FIG. 14 can be convenient when a sheet S separated from a booklet re-adheres to the booklet. This is because a portion of the intermediate stacking section 42 is exposed to the outside, making it easy for the user to stack the sheet S on the intermediate stacking section 42.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-052435, filed Mar. 26, 2025, which is hereby incorporated by reference herein in its entirety.

What is claimed is:

1. A book-making apparatus comprising:
a support plate configured to accept and support a sheet bundle formed by a plurality of sheets having an adhesive layer formed using toner;
a booklet producing unit configured to heat the adhesive layer in the sheet bundle and press the adhesive layer in the sheet bundle to produce a booklet; and
a control unit having at least a first bonding mode and a second bonding mode, and configured to control the booklet producing unit,
wherein a void ratio that is an area ratio between pores and toner contained in the adhesive layer to which the first bonding mode was applied is higher than a void ratio of the adhesive layer to which the second bonding mode was applied.

2. The book-making apparatus according to claim 1, wherein the first bonding mode is applied to a sheet envisioned to be separated from the booklet.

3. The book-making apparatus according to claim 2, wherein the second bonding mode is applied to a sheet that is not envisioned to be separated from the booklet.

4. The book-making apparatus according to claim 1, wherein a heating temperature of the adhesive layer in the first bonding mode is lower than a heating temperature of the adhesive layer in the second bonding mode.

5. The book-making apparatus according to claim 1, wherein, at 120° C., a storage modulus of toner for forming the adhesive layer to which the first bonding mode is to be applied is lower than a storage modulus of toner for forming the adhesive layer to which the second bonding mode is to be applied.

6. The book-making apparatus according to claim 5,
wherein the first bonding mode is applied to the adhesive layer formed using toner having a storage modulus of less than 11500 Pa at 120° C., and
the second bonding mode is applied to the adhesive layer formed using toner having a storage modulus of 11500 Pa or greater at 120° C.

7. The book-making apparatus according to claim 1, wherein, at 120° C., a loss tangent of toner for forming the adhesive layer to which the first bonding mode is to be applied is greater than a loss tangent of toner for forming the adhesive layer to which the second bonding mode is to be applied.

8. The book-making apparatus according to claim 7,
wherein the first bonding mode is applied to the adhesive layer formed using toner having a loss tangent greater than 0.91 at 120° C., and
the second bonding mode is applied to the adhesive layer formed using toner having a loss tangent of 0.91 or less at 120° C.

9. The book-making apparatus according to claim 1, wherein a void ratio of the adhesive layer to which the first bonding mode was applied is 35% or greater, and a void ratio of the adhesive layer to which the second bonding mode was applied is less than 35%.

10. The book-making apparatus according to claim 9, wherein the void ratio of the adhesive layer to which the first bonding mode was applied is 35% or greater and less than 50%.

11. The book-making apparatus according to claim 1, wherein a heating temperature that is applied to the adhesive layer in the first bonding mode and the second bonding mode is 165° C. or higher and lower than a temperature at which heat-induced discoloration occurs in a sheet.

12. The book-making apparatus according to claim 11, wherein a heating temperature of toner to which the first bonding mode is applied is higher than a heating temperature at which an adhesive force of an adhesive layer formed using the toner is maximum.

13. The book-making apparatus according to claim 1, wherein a heating time of the adhesive layer in the first bonding mode is shorter than a heating time in the second bonding mode.

14. The book-making apparatus according to claim 13, wherein the heating time of the adhesive layer in the first bonding mode is 1 second or more and 5 seconds or less, and the heating time in the second bonding mode is 10 seconds or more and less than 30 seconds.

15. The book-making apparatus according to claim 1, further comprising an input device configured to accept selection input for selecting the first bonding mode or the second bonding mode.

16. The book-making apparatus according to claim 1, further comprising an input device configured to accept input designating a page to which the first bonding mode is to be applied.

17. The book-making apparatus according to claim 1, wherein the control unit further has a re-adhesion mode in which the support unit supports a plurality of sheets separated from one or more booklets, and the booklet producing unit causes the plurality of sheets to re-adhere.

18. An image forming apparatus comprising:
an image forming unit configured to form an image on a sheet using toner;
a fixing unit configured to fix the image to the sheet;
a support plate configured to accept and support a sheet bundle discharged from the fixing unit and formed by a plurality of sheets having an adhesive layer formed using the toner;
a booklet producing unit configured to heat the adhesive layer in the sheet bundle and press the adhesive layer in the sheet bundle to produce a booklet; and
a control unit having at least a first bonding mode and a second bonding mode, and configured to control the booklet producing unit,
wherein a void ratio that is an area ratio between pores and toner contained in the adhesive layer to which the first bonding mode was applied is higher than a void ratio of the adhesive layer to which the second bonding mode was applied.

19. A method for controlling an image forming apparatus, the method comprising:
accepting and supporting a sheet bundle formed by a plurality of sheets having an adhesive layer formed using toner;
heating the adhesive layer in the sheet bundle and pressing the adhesive layer in the sheet bundle to produce a booklet; and
controlling a booklet producing process using a first bonding mode or a second bonding mode,
wherein a void ratio that is an area ratio between pores and toner contained in the adhesive layer to which the first bonding mode was applied is higher than a void ratio of the adhesive layer to which the second bonding mode was applied.
